(19) United States
(12) Patent Application Publication
(10) Pub. No.: US 2006/0287809 A1
(43) Pub. Date: Dec. 21, 2006

(54) Method and device for processing information output by redundant primary flight equipment

(75) Inventor: Jean-Louis Lebrun, Antony (FR)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: THALES, Neuilly Sur Seine (FR)

(21) Appl. No.: 10/559,689

(22) PCT Filed: May 24, 2004
(86) PCT No.: PCT/EP04/50902

§ 371 Date: Dec. 6, 2005

(30) Foreign Application Priority Data
Jun. 6, 2003 (FR) 0306884

(51) Int. Cl. G01C 21/00

(52) U.S. Cl. 701/200; 244/76 R

(57) ABSTRACT

The present invention relates to the redundant architectures of processing lines interposed between primary flight equipment doubled or tripled as a safety measure and one or more flight conduct systems. It relates more particularly to the addition, at the head of the processing lines, of anti-noise filters intended to avoid untimely disconnections of an automatic control of a flight conduct system that are not justified by a suspected failure. These anti-noise filters are digital filters operating at the sampling rate of the output signals of the primary flight equipment and not at the lower rate of flight conduct systems.

The present invention pertains to the processing of signals provided to a flight conduct system by primary flight equipment doubled or tripled as a safety measure. It relates more particularly to the processing intended to avoid untimely disconnections of an automatic control of a flight conduct system that are not justified by an actual failure of an equipment delivering or processing the signals used by the automatic control.

A certain amount of flight information, including the attitude of the aircraft, the modulus and the orientation of the speed vector of the aircraft, and the altitude of the aircraft are essential for the piloting of an aircraft. Such information is provided by sensors belonging to onboard equipment known as “primary flight equipment”. Counted among the primary flight equipment are static and dynamic pressure sensors and their associated computer (known as “Air Data System”) making it possible to ascertain the air speed of the aircraft and the inertial platform or platforms delivering the accelerations and the angular velocities of the aircraft which may be brought together within one and the same equipment designated by the initials ADIRS (the acronym standing for “Air Data Inertial Reference System”).

The information essential for piloting is utilized in a raw or preprocessed form by one or more flight conduct systems incorporating automatic controls which facilitate piloting by ensuring either stabilizations of attitude or tracking of presets for trim, heading, slope, course, altitude, speed, etc. The best known of these automatic controls is the automatic pilot and/or flight director.

The primary flight equipment, like flight conduct systems must exhibit an extremely low failure rate which is often achieved only by redundancy, one equipment being doubled or tripled like a flight conduct system, each version of flight conduct system being linked to the various versions of the primary flight equipment by processing lines whose function is to choose the most credible version, from among the various available versions of one and the same item of information, and to detect any mismatch between the various available versions of one and the same item of information that may give rise to the suspicion of an unsignaled failure of one of the versions of primary flight equipment from which the information originates.

### DESCRIPTION OF THE RELATED ART

Usually, the primary flight equipment and the processing lines are doubled up. Each processing line operates independently of the others and comprises a vote device whose function is to choose at each instant the version of flight equipment which provides the information taken into account by the flight system or systems. This vote device makes its choice by applying a criterion of proximity with respect to a value corresponding to the median value of available versions of one and the same item of information shifted by an arbitrary threshold. When two versions of one and the same item of information have very similar values, this being the case when two identical equipments are operating correctly, the vote device tends to switch randomly from one copy to the other thereby introducing nuisance switching noise that may disturb the operation of the flight conduct systems. It is known to limit this random switching by introducing a certain threshold into the operation of the vote device.

The flight information is delivered by the primary flight equipment at rates, for example of the order of 20 milliseconds, that are compatible with the speed of variation of the flight parameters that they measure, this in an asynchronous manner, two versions of a same equipment operating in completely independent ways with distinct clocks. The flight conduct systems utilize the flight information delivered by the primary flight equipment at a lower rate suited to their requirement, for example of the order of 50 milliseconds, based on the speed of reaction of the aircraft to their presets. A preprocessing of the information arising from the primary flight equipment is performed in the flight conduct systems at the lowest rate, so as to reduce their calculation load to the minimum. The asynchronisms between the various versions of equipment linked to their inputs and between their inputs and their outputs are taken into account at the start of each line through the use of buffer memories.

In the case of doubled processing lines, the monitoring of the appropriate operation of the processing lines and of the equipment placed upstream is done by detecting mismatches between the available versions of one and the same item of information output by the two processing lines. When this mismatch becomes too big, then unsignaled poor operation of one of the elements of the processing lines or of one of the versions of a same equipment placed upstream of the processing lines is suspected and it is preferred to shut down the automatic controls dependent on the processing lines. This is achieved with the aid of a subtractor circuit placed at the outputs of the lines and followed by a threshold-based comparator. The threshold-based comparator raises an alarm leading, in case of overshoot of its threshold by the deviation existing between the available versions of one and the same item of information at the output of the two processing lines, to the shutdown or to the disconnection of the operational automatic controls of the flight conduct systems using the information output by the lines.

In an architecture with processing line doubled so as to enhance safety, the hardware and software dissymmetries, the absence of synchronization and the change of rate between inputs and output mean that the noise disturbing the signals of the primary flight equipment, such as noise due to nuisance vibrations of the airframe of the aircraft in the case of inertial platforms, propagates differently along the two lines and may give rise, by artifact, to mismatches sufficient to trigger the threshold-based detector placed at the outputs of the two lines signaling a possibility of poor operation. This is still truer in the case of processing lines liable to significant drifting such as those comprising integrator circuits used to extract speed information from acceleration information, position information from speed information, or to compute accuracy terms intended for the steady state control surface commands.

### SUMMMARY OF THE INVENTION

The present invention is aimed at reducing the frequency of untimely disconnections of automatic controls of a flight conduct system that are due to artifacts of lines for processing primary flight information doubled or tripled so as to enhance safety.

Its subject is a method for processing information output by a primary flight equipment mounted on board an aircraft, in a form sampled at a first rate with a view to being delivered to a flight conduct system of the aircraft at a second rate lower than the first rate, this process being noteworthy in that it consists in submitting the samples of information to an anti-noise digital filtering carried out at the first sampling rate.

Advantageously, the anti-noise digital filtering is an anti-aliasing filtering disabling the undesirable components having frequencies lower than half the first sampling rate and higher than half the second sampling rate.

Advantageously, the anti-noise digital filtering is a first-order low-pass filtering.

Advantageously, the anti-noise digital filtering is a second-order low-pass filtering.

Advantageously, the anti-noise digital filtering is a low-pass or bandstop filtering of Butterworth type.

Advantageously, when the processed information originating from an item of primary flight equipment is affected by noise exhibiting energy spikes, the anti-noise digital filtering is a filtering with stopbands corresponding to the energy spikes of the noise.

Advantageously, the anti-noise digital filtering implements a transfer function dependent on the flight configuration of the aircraft.

Advantageously, the anti-noise filter is a filter with sliding average operating on several samples.

The subject of the invention is also a device for implementing the aforesaid method.

### BRIEF DESCRIPTION OF THE DRAWINGS

Other advantages and characteristics of the invention will emerge from the description below of an embodiment of the invention given by way of example. This description will be offered in conjunction with the drawing in which:

FIG. 1 represents a redundant architecture employed in the prior art, for a line for processing the lateral acceleration information provided by an inertial platform with a view to making it available to a yaw stabilizer automatic control,

FIGS. 2a to 2d are charts of curves illustrating the progression of the deviations between the operating drifts of the two processing lines of the redundant architecture of FIG. 1 in the presence of very noisy sensor signals and the untimely disconnections resulting therefrom for the yaw stabilizer automatic control,

FIG. 3 represents a redundant architecture according to the invention for a line for processing the lateral acceleration information provided by an inertial platform with a view to making it available to a yaw stabilizer automatic control, and

FIGS. 4a to 4d are charts of curves illustrating the controlled operating drifts of the two processing lines of the redundant architecture of FIG. 3 and the very infrequent disabling resulting therefrom for the yaw stabilizer automatic control.

### DETAILED DESCRIPTION OF THE EMBODIEMENT

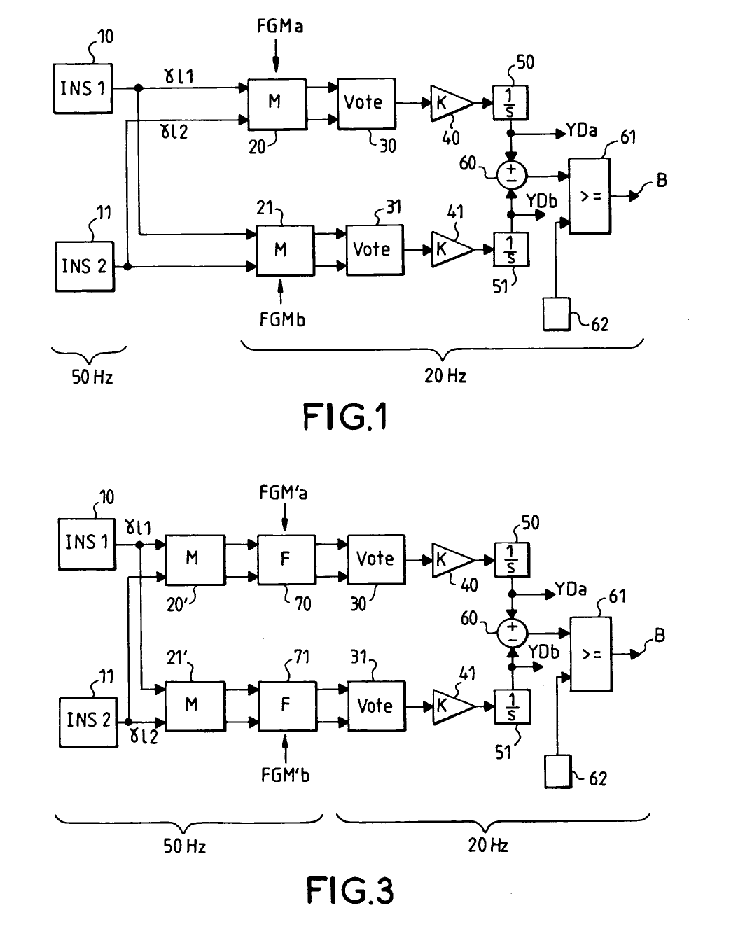

FIG. 1 shows a known type of redundant architecture used for the generation of integrated lateral acceleration information YD destined for a yaw stabilizer automatic control forming part of a flight conduct system and whose function is to damp the yaw oscillations of the aircraft and to zero the angle of sideslip of the aircraft. This redundant architecture utilizes lateral acceleration information γl delivered in parallel and independently by two copies 10, 11 of an inertial platform INS so as to produce likewise independently two versions of anti-sideslip control information YD both intended for the yaw stabilizer automatic control. The constant monitoring of the deviation between the two versions provided YDa and YDb of the control information is used as test of appropriate operation of the elements of the redundant architecture of the yaw stabilizer automatic control. This type of redundant architecture encompasses two operationally identical parallel lines FGMa and FGMb installed on distinct hardware modules.

The two inertial platforms INS 10, 11 deliver, in digital form, and at a repetition rate of 50 Hz (periodicity of 20 ms), two versions γl1 and γl2 of the lateral acceleration information. Their data flows are neither totally identical nor synchronized since they are subject to different vibratory environments on account of their installation at different locations of the airframe of the aircraft and operate independently of one another with independent clocks.

The two parallel processing lines FGMa, FGMb use the two versions γl1 and γl2 of the lateral acceleration information that are delivered asynchronously and at a repetition rate of 50 Hz (periodicity of 20 ms) by the two inertial platforms INS 10, 11 so as to produce by integration, with a repetition rate of 20 Hz (periodicity of 50 ms), two versions of the anti-sideslip control information YDa, YDb.

Each processing line FGMa, FGMb comprises at input a double buffer memory 20, 21, followed by a vote circuit 30, 31, by an amplifier 40, 41 and by an integrator 50, 51.

The double buffer memories 20, 21 are loaded at a rate of 20 Hz with pairs of samples of the lateral acceleration information, the two samples of one and the same pair being output, one by the inertial platform INS 10 and the other by the the inertial platform INS 11 and corresponding to the lateral acceleration information γl1 and γl2 delivered by the the inertial platforms 10, 11 for one and the same time slice.

The vote circuits 30, 31, select, whenever required, that is to say every 20 ms, from the double buffer memory 20, 21 placed upstream, one of the samples of the last pair of samples of lateral acceleration information that was written. For this selection, they implement an arbitrary choice criterion consisting of a vote mechanism such as that described in the preamble. The amplifier circuits 40, 41 followed by the integrator circuits 50, 51 make it possible to extract, by integration, from the samples held by the vote circuits 30, 31, two sampled versions YDa and YDb of anti-sideslip control information intended for a yaw damper automatic control of a flight conduct system.

At the outputs of the two processing lines FGMa and FGMb is a subtractor circuit 60, feeding a threshold-based comparator 61 which receives its threshold from a register 62 and which delivers an order for disabling the automatic controls fed by the two processing lines FGMa and FGMb in case of detection of an overshoot of the threshold by the deviation existing between samples of like rank output by the two lines. Specifically, too big a deviation between samples of like rank of the anti-sideslip control information output by the two processing lines may lead to a fear of poor operation of one of the circuits of the two processing lines FGMa and FGMb.

In the absence of sensor noise, the redundant architecture which has just been described in relation to FIG. 1 makes it possible to safely feed the automatic controls of a flight conduct system. On the other hand, in the presence of very noisy sensor signals, as is encountered with inertial platforms disturbed by vibratory phenomena impinging on the structure of the aircraft, in particular when deploying the landing gear, when deploying flaps or airbrakes, when opening a bay door, when taking on an exterior load, etc., this architecture leads to the issuing of untimely orders for automatic control decoupling.

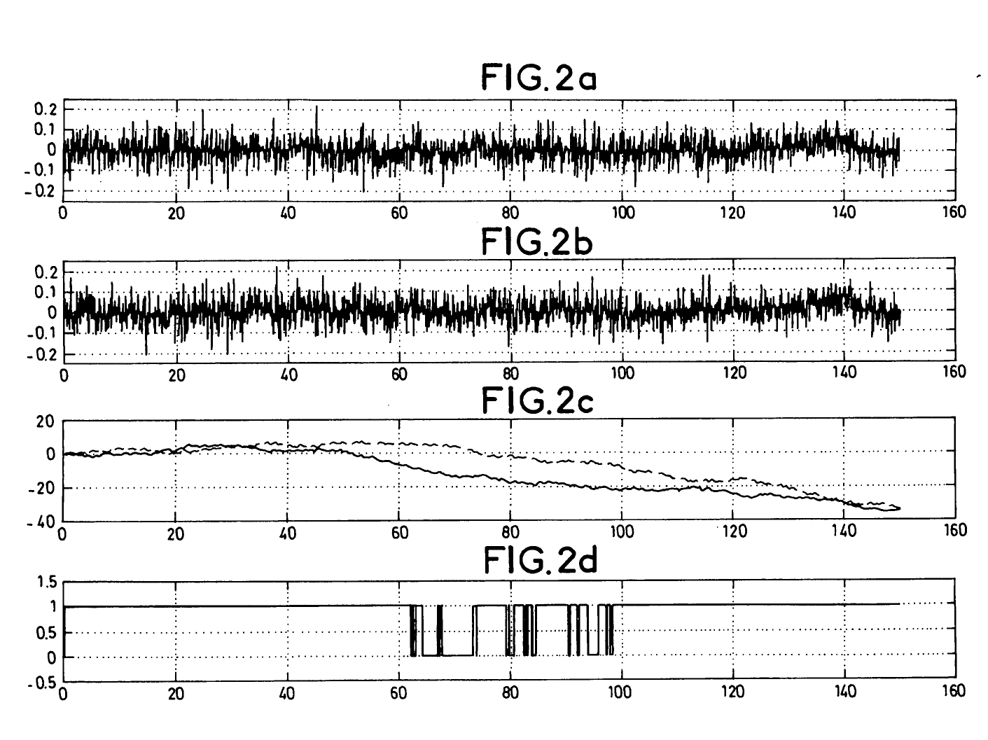

This may be appreciated by studying the charts of FIGS. 2a to 2d relating to the operation over one and the same time period of the two processing lines FGMa and FGMb, in the absence of failure, with very noisy input signals arising from inertial platforms operating appropriately but subjected to nuisance vibrations of the airframe of the aircraft. The chart of FIG. 2a represents a very noisy signal γl1 arising from one 10 of the two inertial platforms INS that is affected by nuisance vibrations of the airframe of the aircraft. The chart of FIG. 2b represents the very noisy signal γl2 arising from the other 11 of the inertial platform INS likewise subjected to nuisance vibrations of the airframe of the aircraft. The general profiles of the signals γl1 and γl2 are the same but the noise affecting them is different, the inertial platforms which deliver them not having the same vibratory surroundings on account of the fact that they are not mounted at exactly the same place in the airframe of the aircraft. The chart of FIG. 2c represents the two versions YDa and YDb of the anti-sideslip control information that are delivered by the two lines FGMa and FGMb in response to the signals γl1 and γl2. The relative progression of the deviation between the two versions YDa and YDb, due to the slow drifting of the integrator circuits 50 and 51 is aggravated by the effects, on the hardware and software dissymmetries of the two processing lines FGMa and FGMb, of the vibratory noise affecting the signals γl1 and γl2. The chart of FIG. 2d shows the state resulting from the disabling order B produced by the threshold-based comparator 61 destined for the automatic controls dependent on the processing lines. Untimely orders for automatic control disabling are noted in the middle of the chart.

To reduce the frequency of untimely orders for disabling the automatic controls dependent on redundant processing lines, it is proposed that an anti-noise filter be placed upstream of the vote circuits. The redundant architecture used for the generation of anti-sideslip control information YD destined for a yaw stabilizer automatic control forming part of a flight conduct system is then modified in accordance with FIG. 3. In this FIG. 3, the elements that are unchanged with respect to FIG. 1, that is to say the two copies of the inertial platform, the vote circuits and the circuits disposed downstream of the vote circuits, retain the same indexations while the circuits that are already present but have changed rate borrow the same labeling labeled with a prime.

The redundant architecture of FIG. 3 differs from that of FIG. 1 through the presence in the two processing lines FGM′a and FGM′b of two double anti-noise filters 70, 71 interposed between the vote circuits 30, 31 and the double buffer memories 20′, 21′ and through the fact that the double buffer memories 20′ and 21′ operate at the rate of 50 Hz which is that of the data originating from the inertial platforms INS 10, 11 and not at the rate of 20 Hz of the signals output by the processing lines.

Each double anti-noise filter 70 or 71 filters in parallel the two series of samples delivered by the two inertial platforms INS 10, 11 at the rate of these series, without subsampling but under the control of its own clock that is not synchronized with either of the clocks of the inertial platforms INS 10, 11.

The double buffer memories 20′ and 21′ working at the higher rate of the data originating from the inertial platforms INS 10, 11, no longer serve for the subsampling but only for the noting of absences of synchronism between the clocks at the same frequency of the inertial platforms INS 10? 11 and of the double anti-noise filters 70, 71.

The double anti-noise filters 70, 71 are digital filters operating at the rate of 50 Hz of the series of data arising from the two inertial platforms INS 10, 11, hence before subsampling, with a view to avoiding at their level, any problems posed by the band aliasings accompanying a subsampling. The subsampling making it possible to go to the rate of 20 Hz of the samples output by the two processing lines FGM′a and FGM′b is done at the level of the outputs of the double anti-noise filters 70, 71 whose registers also serve as buffer memories.

The transfer functions of the double anti-noise filters 70, 71 are chosen in such a way as to best disable the noise affecting the signals of the two inertial platforms INS1, INS2, while perturbing the useful signals as little as possible. They are chosen after studying the vibratory surroundings of each inertial platform as a function of the flight configurations of the aircraft more particularly prone to the appearance of vibrations on the airframe, such as configurations with landing gear deployed, flaps deployed, airbrakes deployed, bay door open, taking on of exterior load, etc. They may even be changed as a function of the current flight configuration. They are advantageously of the low-pass or bandstop type and of any order dependent on the steepness of the cutoff desired. (1^{st}, 2^{nd} order, Butterworth, etc.). They may also be obtained by sliding average over any number of samples.

When the spurious noise is wideband noise brought into the useful band through the aliasing phenomenon resulting from the subsampling making it possible to go from the sampling rate of 50 Hz of the inertial platforms INS 10, 11 to the output sampling rate of 20 Hz of the processing lines FGM′a, FGM′b, the transfer function chosen for the double anti-noise filters is that of an anti-aliasing filter. This anti-aliasing filter may be tuned to disable the components of frequency below half the first sampling frequency of 50 Hz and of frequency above half the second sampling frequency of 20 Hz.

When the spurious noise is due to vibrations from resonance of the airframe of the aircraft at specific frequencies in the useful signal band, the transfer function adopted for the double anti-noise filters may be of bandstop or notch type, with one or more stop frequencies placed at the level of the frequencies of the resonant vibrations developing in the airframe of the aircraft at the locations of the inertial platforms INS 10, 11.

A double anti-noise filter 70 or 71 as well as the control of the double buffer memory 20′ or 21′ which precedes it and carries out the acquisitions of the lateral acceleration information samples delivered by the two inertial platforms INS 10, 11 may form the subject in each line FGM of one and the same software task executed at the same rate.

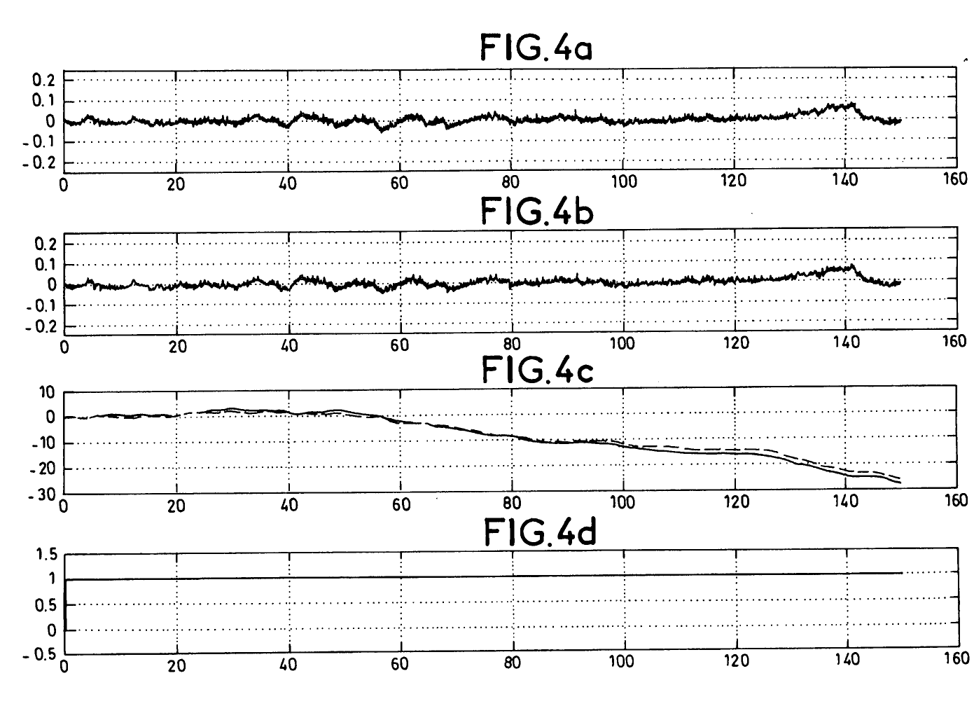

The charts of FIGS. 4a to 4d illustrate the improvement afforded by the anti-noise filters. They are plotted over the same time period and with the same very noisy input signals as those of FIGS. 2a to 2d, still in the absence of any failure of the inertial platforms and of the measurement lines. The chart of FIG. 4a represents the signal γl′1 output after the anti-noise filtering by one 10 of the two inertial platforms INS 10, 11 affected by nuisance vibratory phenomena of the airframe of the aircraft. The chart of FIG. 4b represents the signal γl′2 output, after anti-noise filtering, from the other 11 of the two inertial platforms INS 10, 11 likewise affected by nuisance vibratory phenomena of the airframe of the aircraft. The general profiles of the signals γl′1 and γl′2 and their similarity of appearance are rendered more apparent by the effects of the anti-noise filterings. The chart of FIG. 4c represents the two versions YDa and YDb of the anti-sideslip control information, delivered by the two lines FGMa and FGMb in response to the signals γl1 and γl2. The anti-noise filterings considerably slow down the progression of the deviation between the two versions YDa and YDb in the course of the slow drifting of the integrator circuits 50 and 51, to the point of eliminating the untimely orders for disabling the automatic controls as shown by the chart of FIG. 4d representing the output state of the threshold-based comparator 61.

The redundant architecture with double anti-noise filters that has just been described may be used with any flight conduct system receiving primary flight information, from redundant processing lines having, by their nature, a considerable drift capacity due to accuracy terms comprising integrators, such as lines processing information output by an accelerometric inertial platform IRS, AHRS or accelerometric block and this in any aircraft, be it an airplane, a helicopter, a drone, a missile, etc.

1-22. (canceled)

23. A method for processing information output by a primary flight equipment mounted on board an aircraft, in a form sampled at a first rate with a view to being delivered after processing, to a flight conduct system of the aircraft, in a form sampled at a second rate lower than the first rate, wherein the samples of information output by an item of primary flight equipment are submitted to an anti-noise digital filtering carried out at the first sampling rate.

24. The method as claimed in claim 23, wherein the anti-noise digital filtering is an anti-aliasing filtering disabling the frequency components higher than half the second sampling rate.

25. The method as claimed in claim 23, wherein the anti-noise digital filtering is an anti-aliasing filtering disabling the frequency components lower than half the first sampling rate.

26. The method as claimed in claim 23, wherein the anti-noise digital filtering is an anti-aliasing filtering disabling the frequency components higher than half the second sampling rate and those of frequency lower than half the first sampling rate.

27. The method as claimed in claim 23, wherein the anti-noise digital filtering is a first-order low-pass filtering.

28. The method as claimed in claim 23, wherein the anti-noise digital filtering is a second-order low-pass filtering.

29. The method as claimed in claim 23, wherein the anti-noise digital filtering is a low-pass filtering of Butterworth type.

30. The method as claimed in claim 23, wherein the anti-noise digital filtering is a bandstop filtering of Butterworth type.

31. The method as claimed in claim 23, wherein, when the processed information originating from a primary flight equipment is affected by noise exhibiting energy spikes, the anti-noise digital filtering is a filtering with stopbands corresponding to the energy spikes of the noise.

32. The method as claimed in claim 23, wherein the anti-noise digital filtering is a filtering with sliding average operating on several samples.

33. The method as claimed in claim 23, wherein the anti-noise digital filtering implements a transfer function dependent on the flight configuration of the aircraft.

34. A device with redundant architecture with two parallel lines for the processing of signals from primary flight equipments mounted on board an aircraft, said signals being available at a first rate, in a sampled form and as several versions and intended to be delivered after processing, still as several versions, to a flight conduct system of the aircraft, in a form sampled at a second rate lower than the first rate, wherein it comprises, at the head of each line, following a multiple buffer memory, a multiple anti-noise digital filter filtering in parallel the various available versions of signals from primary flight equipments and operating, like the multiple buffer memory at the first sampling rate.

35. The device as claimed in claim 34, wherein the multiple anti-noise digital filter is an anti-aliasing filter disabling the frequency components higher than half the second sampling rate.

36. The device as claimed in claim 34, wherein the multiple anti-noise digital filter is an anti-aliasing filter disabling the frequency components lower than half the first sampling rate.

37. The device as claimed in claim 34, wherein the multiple anti-noise digital filter is an anti-aliasing filter disabling the frequency components higher than half the second sampling rate and those of frequency lower than half the first sampling rate.

38. The device as claimed in claim 34, wherein the multiple anti-noise digital filter is a first-order low-pass filter.

39. The device as claimed in claim 34, wherein the multiple anti-noise digital filter is a second-order low-pass filter.

40. The device as claimed in claim 34, wherein the multiple anti-noise digital filter is a low-pass filter of Butterworth type.

41. The device as claimed in claim 34, wherein the multiple anti-noise digital filter is a bandstop filter of Butterworth type.

42. The device as claimed in claim 34, wherein, when the processed information output by a primary flight equipment is affected by noise exhibiting energy spikes, the multiple anti-noise digital filter is a filter with stopbands corresponding to the energy spikes of the noise.

43. The device as claimed in claim 34, wherein the multiple anti-noise digital filter is a filter with sliding average operating on several samples.

44. The device as claimed in claim 34, wherein the multiple anti-noise digital filter has a transfer function dependent on the flight configuration of the aircraft.
